(19) United States
(12) Patent Application Publication
(10) Pub. No.: US 2025/0350840 A1
(43) Pub. Date: Nov. 13, 2025

(54) MOTION-COMPENSATED CAMERA VIEWPOINT SHIFT

(71) Applicant: Massachusetts Institute of Technology, Cambridge, MA (US)

(72) Inventors: Julius Liang-Li Tao, Elmhurst, NY (US); Chong U. Lee, Boston, MA (US); Jae S. Lim, Clearwater Beach, FL (US)

(21) Appl. No.: 19/050,486

(22) Filed: Feb. 11, 2025

Related U.S. Application Data
(60) Provisional application No. 63/644,425, filed on May 8, 2024.

(51) Int. Cl. H04N 23/695; G06T 7/246; H04N 21/4788; H04N 23/68

(52) U.S. Cl. CPC H04N 23/695; G06T 7/251; H04N 21/4788; H04N 23/683; G06T 2207/20081

(57) ABSTRACT

The present invention provides systems and methods for motion compensated single camera viewpoint shifting. One or more reference views of a user looking at one of a camera and a screen are captured. Further, for a current active screen view, a virtual camera view is synthesized by motion compensated interpolation between the one or more reference views and the current active screen view. The virtual camera view may comprise a virtual image of the user looking at the screen. The reference views may comprise at least one of: one or more training camera views of the user looking into the camera, each captured at a different orientation of the user relative to the camera; and one or more training screen views of the user looking at the screen, each captured at a different orientation of the user relative to the screen.

This application claims the benefit of commonly owned U.S. provisional patent application No. 63/644,425 filed on May 8, 2024, which is incorporated herein and made a part hereof by reference.

### BACKGROUND OF THE INVENTION

The present invention relates to the field of video conferencing. More specifically, the present invention relates to methods and systems for shifting a camera viewpoint in a video conferencing environment.

In a video conferencing situation using a laptop or a desktop computer, a single camera is typically mounted at the top center of the screen or just outside the screen frame. This makes eye contact with the other people in the video conference impossible since the camera is not mounted in the middle of the screen.

Many attempts exist to model a human head in 3D and to reorient the head toward the camera. However, 3D modeling and manipulation is computationally intensive and power consuming.

Other attempts simply modify the eye gaze without reorienting the head to give the illusion that the eyes are looking at the camera. These methods force direct eye contact without allowing gaze deviations, which leads to an unnatural experience.

It would be advantageous to provide camera viewpoint shifting to improve eye gaze to provide a more natural video conference experience while using a single camera. It would be advantageous to enable such viewpoint shifting using two-dimensional frame interpolation techniques to synthesize a virtual image as if the camera was located at a focal point of the computer viewing screen. This method improves gaze direction without forcing constant eye contact.

The methods and systems of the present invention provide the foregoing and other advantages.

### SUMMARY OF THE INVENTION

The present invention relates to methods and systems for shifting the camera viewpoint in a video conferencing situation to improve eye gaze. In particular, the present invention provides motion estimation and interpolation techniques adapted to synthesize a virtual image between one or more reference images and each active image. These virtual images estimate what would have been captured had a physical camera been located in the center of the viewing screen. Reference images of the user looking into the physical camera and/or at the center of the viewing screen are captured during a calibration session or the active video session. Active images are captured from the physical camera location, where the user may look towards the camera or away from the camera. The synthesized virtual images are played back in the video stream to restore eye contact while preserving natural gaze deviations. The methods of the present invention can provide a more natural video conferencing experience while using the existing single camera of a computer, laptop, smartphone, or other hand-held device.

The methods of the present invention employ a 2D-only technique that relies on a motion compensation technique typically used in video sequence processing. Instead of computing the motion information in successive frames across time, the correspondences between an initial frame of the subject oriented toward the camera (captured before the active session) and the active frames from the true view (captured during the active session) are computed. The correspondences between the initial oriented view and the first active frame can be found the same way motion information is computed between two successive video frames. These correspondences are termed “motion vectors” herein, as they can be produced by motion estimation techniques.

Accordingly, a virtual camera view can be produced by estimating the vertical motion vectors for the active frame and using them to interpolate from the active frame to a more direct orientation, producing a camera viewpoint shift.

Motion estimation typically uses only two-dimensional processing. Motion interpolation is similarly two-dimensional processing only.

It should be appreciated that the terms “correspondence”, “motion correspondence”, “motion vectors”, and “motion vector field”, may be used interchangeably.

In one example embodiment of the present invention, a method for motion compensated single camera viewpoint shifting is provided. The method may comprise capturing one or more reference views of a user looking at one of a camera and a screen. Further, for a current active screen view, the method may comprise synthesizing a virtual camera view by motion compensated interpolation between the one or more reference views and the current active screen view. The virtual camera view may comprise a virtual image of the user looking at the screen.

In one example embodiment, the one or more reference views comprises one or more training camera views of a user looking into the camera. In such an embodiment, the method may further comprise determining the one or more training camera views that best matches the current active screen view, estimating motion vectors between the matched training camera view and the current active screen view, and interpolating the current active screen view using the motion vectors to synthesize the virtual camera view.

In a further example embodiment, the one or more reference views may comprise at least one of: (a) one or more training camera views of the user looking into the camera, each of the one or more training camera views captured at a different orientation of the user relative to the camera; and (b) one or more training screen views of the user looking at the screen, each of the one or more training screen views captured at a different orientation of the user relative to the screen.

The synthesizing of the virtual camera view may further comprise determining the one or more training screen views that best matches the current active screen view, estimating first motion vectors between the matched training screen view and the current active screen view, estimating second motion vectors between the matched training screen view and a corresponding one of the one or more training camera views, mapping the second motion vectors onto the current active screen view using the first motion vectors to derive third motion vectors, and interpolating the current active screen view using the third motion vectors to synthesize the virtual camera view.

Each of the one or more training camera views may be paired with a corresponding training screen view of the one or more training screen views.

The reference views may further comprise one or more of: updated training camera views obtained during a video conference; and updated training screen views obtained during the video conference. Prior synthesized virtual camera views and/or prior active screen views may be used to produce the updated training camera views or the updated training screen views.

A series of the virtual camera views may be produced as the video conference progresses.

At least one of the x-component or the y-component of one or more of the first motion vector, the second motion vector, or the third motion vector may be one of: set to zero; multiplied by a number; and provided with a fixed bias.

Each of the third motion vectors may comprise a horizontal x-component and a vertical y-component, the third motion vectors being defined as Mac(n)[dx, dy]. The x-component of the third motion vectors may be set to zero to obtain modified third motion vectors defined as Mac(n)[d0, dy]. The modified third motion vectors may be utilized in the interpolating step.

The camera may be mounted outside of a viewing area of the screen. For example, the camera may be mounted to the screen frame, typically in the top center of the frame. However, the location may vary depending on the type of device (desktop computer, laptop, smartphone, tablet, or the like) and the camera may be positioned in any area of the screen frame or within the screen but outside the viewing area.

A location of the virtual camera view may be selectable by the user. However, a relative location between the camera and the virtual camera view remains constant regardless of a position or angle of a user's face relative to the screen.

The present invention also encompasses systems for motion compensated single camera viewpoint shifting. An example embodiment of a system in accordance with the present invention may comprise a camera for capturing one or more reference views of a user looking at one of the camera and a screen associated with the camera, and a processing module adapted for synthesizing a virtual camera view for a current active screen view by motion compensated interpolation between the one or more reference views and the current active screen view. The virtual camera view may comprise a virtual image of the user looking at the screen.

Various embodiments of the system of the present invention may also encompass the features and functionality of the method embodiments discussed above.

### BRIEF DESCRIPTION OF THE DRAWINGS

The present invention will hereinafter be described in conjunction with the appended drawing figures, wherein like reference numerals denote like elements, and:

FIG. 1 (FIGS. 1A, 1B, and 1C) shows an overview of an example embodiment of the present invention;

FIG. 2 shows an example embodiment of a system diagram in accordance with the present invention, utilizing a single reference view;

FIG. 3 shows an example embodiment of a flow diagram of a single reference view embodiment of the present invention;

FIG. 4 shows an example embodiment of a system diagram in accordance with the present invention, utilizing multiple reference views;

FIG. 5 shows an example embodiment of a system diagram in accordance with the present invention, utilizing multiple reference views and updated reference views; and

FIG. 6 shows an example embodiment of a flow diagram of a multiple reference view embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The following abbreviations are used in the description and drawings:

MCVPS—Motion-Compensated Viewpoint Shift

N—current step time

n—prior step time: any of 0, 1, 2, . . . , N−1

ASV(n)—Active Screen View at step time n

TCV—Training Camera View

TSV—Training Screen View

UTCV—Updated training Camera View

UTSV—Updated Training Screen view

VCV(n)—Virtual Camera View at step time n

Mac—Motion vector from active screen view (ASV) to training camera view (TCV)

Msa—Motion vector from training screen view (TSV) to active screen view (ASV)

Msc—Motion vector from training screen view (TSV) to training camera view (TCV)

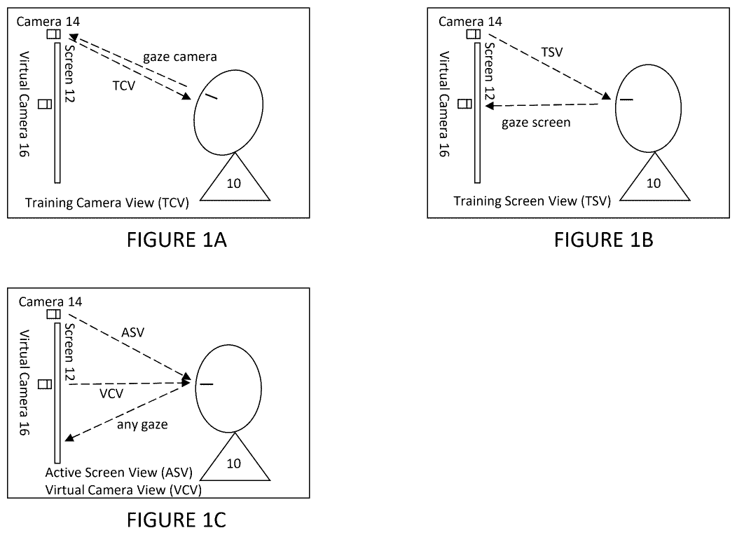

FIGS. 1A, 1B, and 1C show an example embodiment of the present invention in which a method for motion compensated single camera viewpoint shifting is provided. The method may comprise capturing one or more reference views of a user 10 looking at one of a screen 12 and a camera 14. The reference views may comprise a TCV (Training Camera View) as shown in FIG. 1A and/or a TSV (Training Screen View) as shown in FIG. 1B) Further, for a current active screen view ASV, the method may comprise synthesizing a virtual camera view VCV as shown in FIG. 1C, by motion compensated interpolation between the one or more reference views TSV, TCV and the current active screen view ASV. The virtual camera view VCV may comprise a virtual image of the user 10 looking at the screen 12. For example, the virtual camera view VCV may show a virtual image of the user 10 looking at the center of the screen 12 (or other designated point on the screen 12). The one or more reference views TSV, TCV may comprise at least one of: (a) one or more training camera views TCV of the user 10 looking into the camera 14, each of the one or more training camera views TCV captured at a different orientation of the user 10 relative to the camera 14; and (b) one or more training screen views TSV of the user 10 looking at the screen 12, each of the one or more training screen views TSV captured at a different orientation of the user 10 relative to the screen 12.

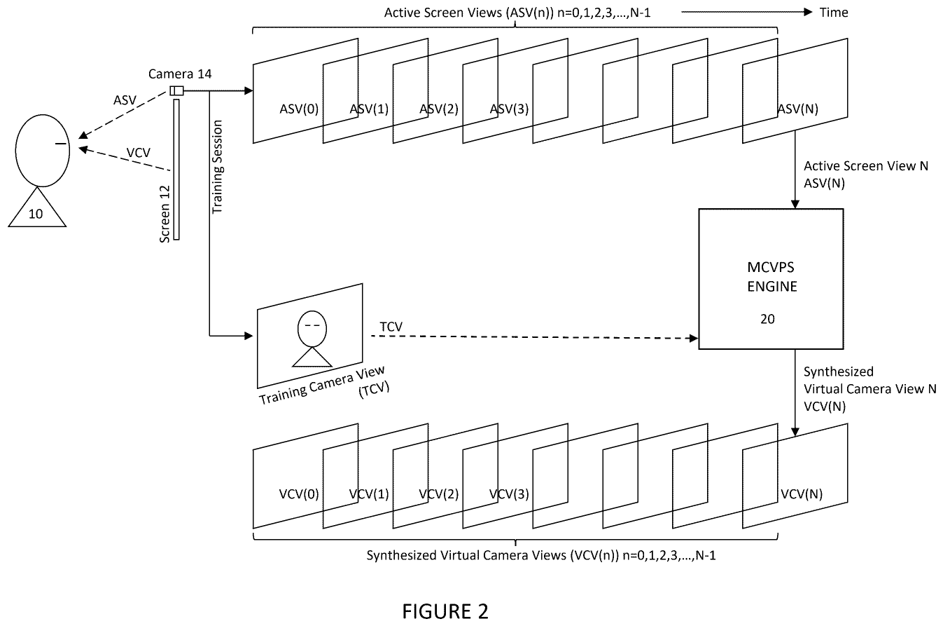

FIG. 2 shows an example embodiment of a system for motion compensated single camera viewpoint shifting in accordance with the present invention, which utilizes a single reference view. The system may comprise the screen 12 and camera 14 as discussed above. A motion compensation viewpoint shift (MCVPS) Engine 20 (also referred to herein as a “processing module”) is provided which is in communication with the camera 14. In the FIG. 2 embodiment, the reference view is shown as one of the training camera views TCV.

As shown in FIG. 2, the synthesizing of the virtual camera view VCV may further comprise determining the one or more training camera views TCV that best matches the current active screen view ASV, estimating motion vectors between the matched training camera view TCV and the current active screen view ASV, and interpolating the current active screen ASV view using the motion vectors to synthesize the virtual camera view VCV. The process is repeated for each active screen view ASV(n)=ASV(0), ASV(1), ASV(2), . . . ASV(N) during the video conference to produce a corresponding series of virtual camera views VCV(n)=VCV(0), VCV(1), VCV(2), . . . VCV(N).

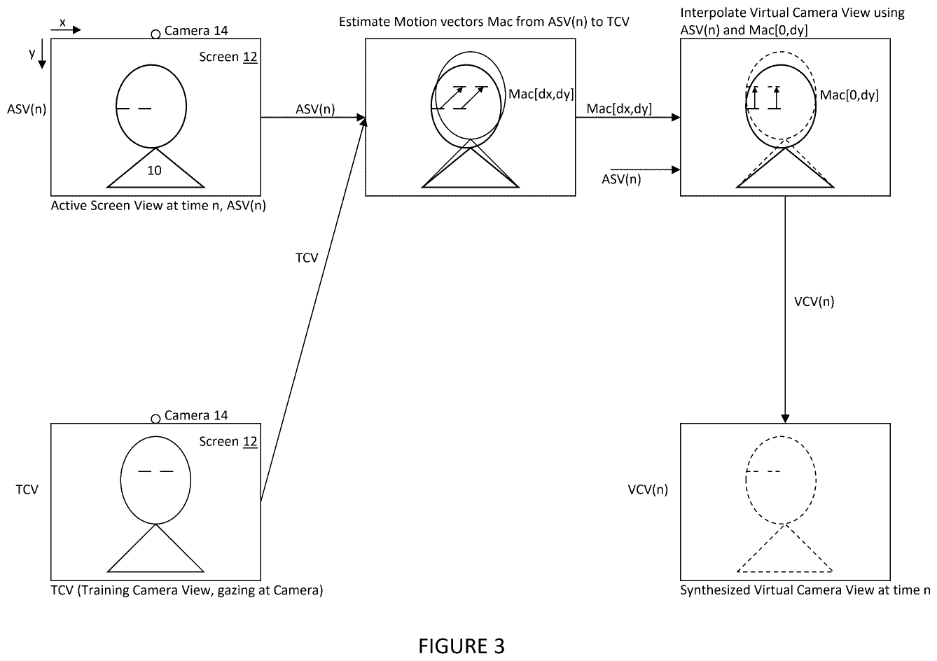

As shown in FIG. 3, each of the motion vectors may comprise a horizontal x-component and a vertical y-component, the motion vectors being defined as Mac(n)[dx, dy] (the motion vector describing the training cumulative motion between ASV and TCV). The x-component of the motion vectors may be set to zero to obtain modified motion vectors defined as Mac(n)[d0, dy]. This would allow a freedom of motion for the user to look away from the center of the screen. The modified motion vectors may be utilized in the interpolating step.

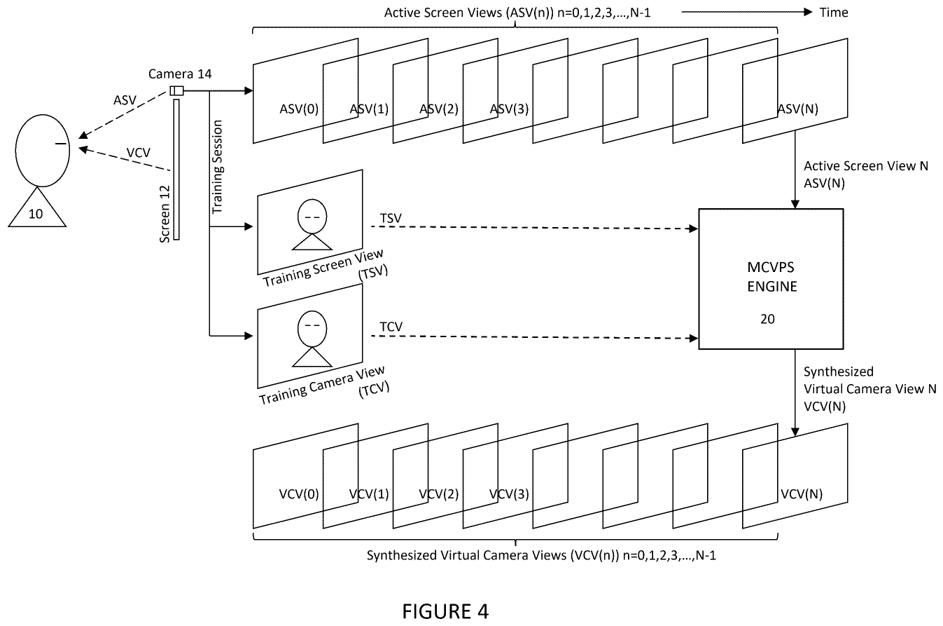

FIG. 4 shows an example embodiment of a system for motion compensated single camera viewpoint shifting in accordance with the present invention, which utilizes multiple reference views TSV, TCV. As discussed above in connection with FIG. 2, the system may comprise the screen 12, camera 14, and MCVPS Engine 20.

As shown in FIG. 4, the synthesizing of the virtual camera view VCV may comprise determining the one or more training screen views TSV that best matches the current active screen view ASV, estimating first motion vectors between the matched training screen view TSV and the current active screen view ASV, estimating second motion vectors between the matched training screen view TSV and a corresponding one of the one or more training camera views TCV, mapping the second motion vectors onto the current active screen view ASV using the first motion vectors to derive third motion vectors, and interpolating the current active screen ASV view using the third motion vectors to synthesize the virtual camera view VCV. The process is repeated for each active screen view ASV(n)=ASV(0), ASV(1), ASV(2), . . . ASV(N) during the video conference to produce a corresponding series of virtual camera views VCV(n)=VCV(0), VCV(1), VCV(2), . . . VCV(N).

Each of the one or more training camera views TCV from a series of training camera views TCVs may be paired with a corresponding training screen view TSV of the one or more training screen views TSV from a series of training screen views TSVs.

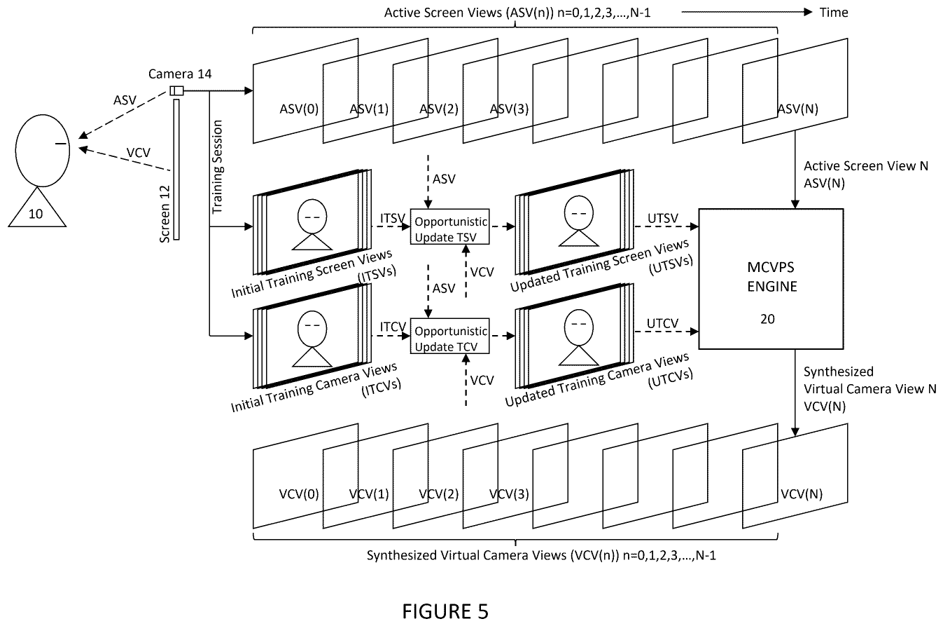

As shown in FIG. 5, the reference views may further comprise one or more of: updated training camera views UTCVs obtained during a video conference; and updated training screen views UTSVs obtained during the video conference. Prior synthesized virtual camera views VCV(0), VCV(1), . . . VCV(N) and/or prior active screen views ASV(0), ASV(1), ASV(2), . . . ASV(N) may be used to produce the updated training camera views UTCVs or the updated training screen views UTSVs. For example, if a prior synthesized virtual camera view shows a user looking at the camera, it can be used to update the training camera view TCV to produce a UTCV. A prior synthesized virtual camera view VCV which shows a user looking at the screen can be used to update the training screen views TSV to produce a UTSV.

It should be appreciated that the reference views may comprise any of the views (or combination of views) available to the MCVPS engine 20.

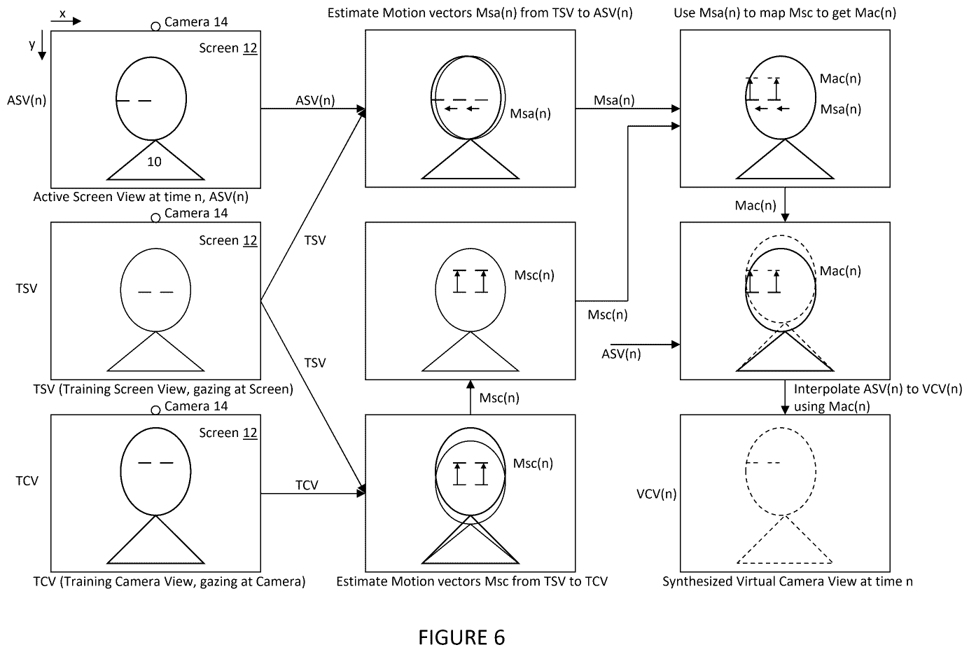

FIG. 6 shows an example of the processing steps for the multiple reference view embodiments discussed above in connection with FIGS. 4 and 5. For each of the current active screen views ASV(n), a training screen view TSV and corresponding training camera view TCV are selected that best match the current active screen view ASV. First motion vectors Msa(n) between the matched training screen view TSV and the current active screen view ASV are estimated. Second motion vectors Msc(n) between the matched training screen view TSV and a corresponding one of the training camera views TCV are estimated. The second motion vectors Msc(n) may then be mapped onto the current active screen view ASV(n) using the first motion vectors Msa(n) to derive third motion vectors Mac(n). The current active screen ASV(n) view can then be interpolated using the third motion vectors Mac(n) to synthesize the virtual camera view VCV(n).

The second motion vectors Msc(n) between the matched training screen view TSV and the training camera view TCV can be estimated during the training session, prior to the current stage of the video conference. Then, during the process of synthesizing the virtual camera view VCV, the first motion vector Msa(n) can be used to look up the corresponding second motion vector Msc(n).

As discussed above in connection with FIG. 3, each of the third motion vectors may comprise a horizontal x-component and a vertical y-component, the third motion vectors being defined as Mac(n)[dx, dy]. The x-component of the third motion vectors may be set to zero to obtain modified third motion vectors defined as Mac(n)[d0, dy]. The modified third motion vectors may be utilized in the interpolating step.

It should be appreciated that the zeroing the x-component of the third motion vector is optional, and it is used to provide freedom of motion in the x-direction when the camera is mounted on a top of the viewing screen. The y-component of the third motion vector may be zeroed depending on which direction freedom of movement is given for user motion. For example, the y-component may be zeroed if the camera is mounted on a left or right side of the viewing screen.

Further, at least one of the x-component or the y-component of one or more of the first motion vector, the second motion vector, or the third motion vector may be one of: set to zero; multiplied by a number; and provided with a fixed bias. The end goal is to compute the bias between the training camera view TCV and the training screen view TSV (reference views) and map this to the active screen view to interpolate the virtual camera view VCV. Any intentional deviation of the active screen view (including looking away from the center of the screen) should be allowed. Only the actual camera position and the desired camera position is compensated for. The user is free to make any head movement in both x and y directions away from the screen.

It is also possible to make small adjustments for the user's z motion, the distance of the user's head from the screen or the camera. This can be estimated in various ways, including the size of the head relative to the head in the reference views. The smaller the head appears in the active view, the further away the person is and less compensation is needed (smaller motion vectors). For example, the magnitude of the motion vectors can be scaled accordingly to compensate for the z distance variations.

The camera 14 may be mounted on an outside of a viewing area of the screen 12. For example, the camera 14 may be mounted to the screen frame, typically in the top center of the frame. However, the location may vary depending on the type of device (desktop computer, laptop, smartphone, tablet, or the like) and the camera 14 may be positioned in any area of the screen frame or within the screen but outside the viewing area.

A location of the virtual camera view may be selectable by the user. However, a relative location between the camera and the virtual camera view remains constant regardless of a position or angle of a user's face relative to the screen.

The user is able to select or define where they want the virtual camera to be located at, which may not necessarily be at the center of the screen 12. Once the virtual camera location is selected, the relative location between the virtual and physical cameras needs to be consistent. That means the user is able to look at other parts of the screen or even look away from the screen and the virtual camera remains where it should be. It does not force the user's face to always point at the virtual camera location. Forcing the user to always look at the center of the screen would be unnatural. The fixed bias between the virtual camera and the physical camera can be applied to the physical camera view.

It is noted that in some instances (depending on where the user is looking in the active screen view ASV), there may be errors in the resulting virtual camera view VCV achieved with the FIG. 6 processing steps (e.g., missing pixels that would be visible in VCV but not ASV when for example the user 10 is looking down, hiding a portion of the user's neck). These errors may be corrected by using additional reference views, including but not limited to training screen views, training camera views, prior virtual camera views, and prior active screen views, and interpolating the missing pixels using pixels visible in any of such reference views.

The missing pixels from occlusion, for example, can come from the reference views such as the initial training camera view (ITCV) or the updated training camera view (UTCV) that comes from a prior virtual camera view (VCV(n)). In case of the pixels coming from a prior VCV(n), there could be an error accumulation over time since those pixels are re-used in each subsequent interpolation. A compensation technique can be introduced to reduce the error accumulation as necessary. A lighting change over time may be one of the factors that affects the compensation.

It is noted that there may be conflicting pixels from occlusion (e.g., background pixels that are covered by a moving foreground). A technique to estimate (relative) depth can be introduced to determine the pixels that should overwrite other pixels in the interpolated image.

In addition, there may be visible boundaries between regions of pixels borrowed from different source images. Pixels along this boundary may differ due to changes in both local and global lighting over time. A compensation technique for color correction can be introduced to blend boundaries to smooth transitions.

Finally, there may be visible errors in detailed areas like the eyes. While small pixel errors in large uniform areas like the forehead or the cheeks are tolerable, similar errors are more obvious and problematic in small intricate areas like the eyes or ears. An up-sampling technique can be introduced to process such detailed areas.

It should now be appreciated that the present invention provides advantageous methods and systems for motion compensated single camera viewpoint shifting.

Although the invention has been described in connection with various illustrated embodiments, numerous modifications and adaptations may be made thereto without departing from the spirit and scope of the invention as set forth in the claims.

What is claimed is:

1. A method for motion compensated single camera viewpoint shifting, comprising:
capturing one or more reference views of a user looking at one of a camera and a screen;
for a current active screen view, synthesizing a virtual camera view by motion compensated interpolation between the one or more reference views and the current active screen view;
wherein the virtual camera view comprises a virtual image of the user looking at the screen.

2. A method in accordance with claim 1, wherein the one or more reference views comprises one or more training camera views of a user looking into the camera, the synthesizing of the virtual camera view further comprising:
determining the one or more training camera views that best matches the current active screen view;
estimating motion vectors between the matched training camera view and the current active screen view, and
interpolating the current active screen view using the motion vectors to synthesize the virtual camera view.

3. The method in accordance with claim 1, wherein the one or more reference views comprise at least one of:
one or more training camera views of the user looking into the camera, each of the one or more training camera views captured at a different orientation of the user relative to the camera; and
one or more training screen views of the user looking at the screen, each of the one or more training screen views captured at a different orientation of the user relative to the screen.

4. The method in accordance with claim 3, wherein the synthesizing of the virtual camera view further comprises:
determining the one or more training screen views that best matches the current active screen view;
estimating first motion vectors between the matched training screen view and the current active screen view;
estimating second motion vectors between the matched training screen view and a corresponding one of the one or more training camera views;
mapping the second motion vectors onto the current active screen view using the first motion vectors to derive third motion vectors;
interpolating the current active screen view using the third motion vectors to synthesize the virtual camera view.

5. The method in accordance with claim 4, wherein each of the one or more training camera views is paired with a corresponding training screen view of the one or more training screen views.

6. The method in accordance with claim 4, wherein the reference views further comprise one or more of:
updated training camera views obtained during a video conference; and
updated training screen views obtained during the video conference.

7. The method in accordance with claim 4, wherein a series of the virtual camera views are produced as the video conference progresses.

8. The method in accordance with claim 4, wherein at least one of the x-component or the y-component of one or more of the first motion vector, the second motion vector, or the third motion vector may be one of: set to zero; multiplied by a number; and provided with a fixed bias.

9. The method in accordance with claim 4, wherein:
each of the third motion vectors comprising a horizontal x-component and a vertical y-component, the third motion vectors being defined as Mac(n)[dx, dy];
the x-component of the third motion vectors are set to zero to obtain modified third motion vectors defined as Mac(n)[d0, dy];
the modified third motion vectors are utilized in the interpolating step.

10. The method in accordance with claim 1, wherein the camera is mounted on an outside of a viewing area of the screen.

11. The method in accordance with claim 1, wherein a location of the virtual camera view is selectable by the user.

12. The method in accordance with claim 11, wherein a relative location between the camera and the virtual camera view remains constant regardless of a position or angle of a user's face relative to the screen.

13. A system for motion compensated single camera viewpoint shifting, comprising:
a camera for capturing one or more reference views of a user looking at one of the camera and a screen associated with the camera;
a processing module adapted for synthesizing a virtual camera view for a current active screen view by motion compensated interpolation between the one or more reference views and the current active screen view;
wherein the virtual camera view comprises a virtual image of the user looking at the screen.

14. A system in accordance with claim 13, wherein the one or more reference views comprises one or more training camera views of a user looking into the camera, the synthesizing of the virtual camera view further comprising:
determining the one or more training camera views that best matches the current active screen view;
estimating motion vectors between the matched training camera view and the current active screen view, and
interpolating the current active screen view using the motion vectors to synthesize the virtual camera view.

15. The system in accordance with claim 13, wherein the one or more reference views comprise at least one of:
one or more training camera views of the user looking into the camera, each of the one or more training camera views captured at a different orientation of the user relative to the camera; and
one or more training screen views of the user looking at the screen, each of the one or more training screen views captured at a different orientation of the user relative to the screen.

16. The system in accordance with claim 15, wherein the synthesizing of the virtual camera view further comprises:
determining the one or more training screen views that best matches the current active screen view;
estimating first motion vectors between the matched training screen view and the current active screen view;
estimating second motion vectors between the matched training screen view and a corresponding one of the one or more training camera views;
mapping the second motion vectors onto the current active screen view using the first motion vectors to derive third motion vectors;
interpolating the current active screen view using the third motion vectors to synthesize the virtual camera view.

17. The system in accordance with claim 16, wherein each of the one or more training camera views is paired with a corresponding training screen view of the one or more training screen views.

18. The system in accordance with claim 16, wherein the reference views further comprise one or more of:
updated training camera views obtained during a video conference; and
updated training screen views obtained during the video conference.

19. The system in accordance with claim 16, wherein a series of the virtual camera views are produced as the video conference progresses.

20. The system in accordance with claim 16, wherein at least one of the x-component or the y-component of one or more of the first motion vector, the second motion vector, or the third motion vector may be one of: set to zero; multiplied by a number; and provided with a fixed bias.

21. The system in accordance with claim 16, wherein:
each of the third motion vectors comprising a horizontal x-component and a vertical y-component, the third motion vectors being defined as Mac(n)[dx, dy];
the x-component of the third motion vectors are set to zero to obtain modified third motion vectors defined as Mac(n)[d0, dy];
the modified third motion vectors are utilized in the interpolating step.

22. The system in accordance with claim 13, wherein the camera is mounted on an outside of a viewing area of the screen.

23. The system in accordance with claim 13, wherein a location of the virtual camera view is selectable by the user.

24. The system in accordance with claim 23, wherein a relative location between the camera and the virtual camera view remains constant regardless of a position or angle of a user's face relative to the screen.
